(19) United States
(12) Patent Application Publication
(10) Pub. No.: US 2020/0119904 A1
(43) Pub. Date: Apr. 16, 2020

(54) TAMPER-PROOF PRIVILEGED USER ACCESS SYSTEM LOGS

(71) Applicant: CA, Inc., New York, NY (US)

(72) Inventors: Richard W. Philyaw, Columbus, GA (US); George D. Watts, Kanata (CA); Steven Cornelis Versteeg, Ivanhoe (AU)

(21) Appl. No.: 16/160,573

(22) Filed: Oct. 15, 2018

(51) Int. Cl. H04L 9/06; G06F 17/30; G06F 21/60; H04L 29/06; G06Q 20/40

(52) U.S. Cl. CPC H04L 9/0637; G06F 17/30371; G06F 17/30377; G06F 21/602; G06Q 2220/00; H04L 63/0421; G06Q 20/401; H04L 2209/38; H04L 63/102

(57) ABSTRACT

One or more access events can be logged to a system log. The system log includes a history of recorded user device actions. A request associated with modifying the system log can be received. The modifying of the system log may be denied based at least in part on a plurality of distributed nodes invalidating the request. Each of the plurality of distributed nodes may include a copy of the system log. The invalidating of the request may include comparing contents of the copy of the system log with the request.

### BACKGROUND

Privileged Access Management (PAM) is technology infrastructure that helps groups or organizations restrict access of particular actions or resources (e.g., files, applications, changes in network settings, etc.) by managing “who” or “what” has specific privileges on a network. Particular individuals or processes are “privileged” because they have the authority to make administrative changes to a network or other resources, while others do not have such privilege. For example, some PAM solutions restrict access of particular applications to one or more individuals based on a company role (e.g., an administrator, a Chief Financial Officer, etc.). In another example, some solutions only allow particular users to access documents with read-only privileges (as opposed to write privileges) so that these users cannot modify the documents. In yet another example, an IT administrator of a corporation may have privileges to configure servers, firewalls, and cloud storage. However, any member of a sales team of the same corporation would likely not have the same privileges. However, the members of the sales team may have privileges associated with accessing sales data, for example.

One problem with privileged access is that particular users can and do abuse their particular privileges by trying to gain access to resources or actions that are undesirable for organizations. For example, a user within an organization may gain access into a financial account database to steal money. One mechanism organizations may employ to reduce these breaches is a system log. A system log is a file that automatically records an audit trail of each transaction or event that has occurred on a given network. For example, the system log can record each session, transaction, or download that each user makes. Accordingly, an organization administrator can query the system logs to identify particular events that users may have engaged in and which are associated with a particular breach. A weakness in current methods of storing system logs is that an unauthorized user with privileged access may try to mask evidence of their attack by using their privileged access to modify the system log.

### SUMMARY

Embodiments of the present disclosure are directed to a computer-implemented method, a non-transitory computer storage medium, and a node of a distributed ledger system. In some embodiments, the computer-implemented method includes the following operations. A node of a distributed plurality of nodes stores a received first transaction block onto a local copy of a blockchain maintained at least in part by the node. The first transaction block includes information indicating a first access event of a system log. The first access event indicates an action performed by a user device. The system log includes a history of recorded user device actions. The node receives a transaction request associated with adding a second transaction block onto the local copy of the blockchain. The transaction request includes a request to store a second access event to the system log. The node writes the second transaction block on to the local copy of the blockchain and adds the second access event to the system log based at least on two or more of the plurality of nodes validating the transaction request.

The non-transitory computer storage medium stores computer-useable instructions that, when used by one or more computing devices, cause the one or more computing devices to perform the following operations in some embodiments. One or more access events are logged to a system log. The system log includes a history of recorded user device actions. A request associated with modifying the system log is received. The modifying of the system log is denied based at least in part on a plurality of distributed nodes invalidating the request. Each of the plurality of distributed nodes includes a copy of the system log. The invalidating of the request includes comparing contents of the copy of the system log with the request.

The node of the distributed ledger system includes one or more processors and one or more computer storage media that store computer-useable instructions that, when used by the one or more processors, cause the one or more processors to perform the following operations according to some embodiments. A first block is written onto a local copy of a blockchain that is maintained at least in part by the node. The first block includes information associated with a first access event. The first access event indicates a privileged action performed by a user device while initiating access to or connected to a computer network. The privileged action corresponds to a user or process having authority to make one or more administrative changes to the computer network or other resource within the computer network. The node receives a transaction request associated with adding a second block onto the local copy of the blockchain. The node stores or does not store the second block on to the local copy of the blockchain based on a plurality of nodes validating or invalidating the transaction request.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is an exemplary system diagram of a distributed ledger network in accordance with some embodiments.

FIG. 2 is an exemplary system diagram of a computing environment, in accordance with some embodiments.

FIG. 3 is a block diagram of a computing environment associated with logging access events, in accordance with some embodiments.

FIG. 4 is a schematic diagram illustrating the contents of the blocks 312-1 and 312-2 of FIG. 3, in accordance with some embodiments.

FIG. 5 is a block diagram of a public or private network system, in accordance with some embodiments.

FIG. 6 is a block diagram of a consortium system, in accordance with some embodiments.

FIG. 7 is a flow diagram of an example process for adding blocks onto a blockchain with respect to access events, in accordance with some.

FIG. 8 is a flow diagram of an example process for denying a request to modify a system log, in accordance with some embodiments.

FIG. 9 is a block diagram depicting an example node of a distributed ledger network, in accordance with some embodiments.

FIG. 10 is a block diagram of an example computing device, in accordance with some embodiments.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter also might be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described. As used herein, the singular forms “a,” “an,” and “the” are intended to include the plural forms as well, unless the context clearly indicates otherwise.

Existing technologies employ system logs that are inherently insecure because they can be altered and because they are managed by a single centralized entity (e.g., a single backend trust server computing device). The majority of enterprise security breaches are related to hijacking or abuse of accounts that have special privileges or permission. In such situations, users may obtain or already have a level of access that makes it possible to edit system logs in order to cover their tracks and effectively rewrite system logs. For example, an administrator user may engage in an access event where the administrator installs particular sensitive files (e.g., describing how to make a particular trade secret). Although the administrator may have privileges to install such files, it may be undesirable for an organization to allow any download or installation of such proprietary information regardless of their privileges. The user may then engage in “covering his tracks” by accessing the system logs on a central server and deleting the access event within the logs corresponding to the install of the particular applications. Accordingly, upon an audit of the system log, there may be no trace that the administrator ever engaged in installing the particular applications. Consequently, the administrator may effectively get away with stealing this valuable information.

Various embodiments of the present disclosure improve existing PAM technology infrastructure and/or existing system log functionality by employing aspects of distributed ledger network functionality (e.g., blockchain) to prevent this type of privileged abuse. A distributed ledger network in accordance with embodiments includes a distributed, decentralized, and cryptographically-sealed system of nodes where copies of system logs are stored on the nodes of the system. In response to data and/or access events being validated for logging, there are multiple, distributed copies of the system logs that are stored to the plurality of nodes. All or a “consensus” of these “validation” nodes must agree on what the correct contents of the system log is. That is to say, the contents of the system logs must be the same for every copy. Accordingly, there is no single place (e.g., a central server) where the system log can be edited because even if one copy is requested for edit, all of the other nodes that include the copy must agree on the edit but will not if it causes a change in the system log. Furthermore, each block in the distributed ledger network may include a hash or encrypted data, which proves the veracity of all the transactions, and any attempts to tamper with the log would need to break this cryptography, as described in more detail below.

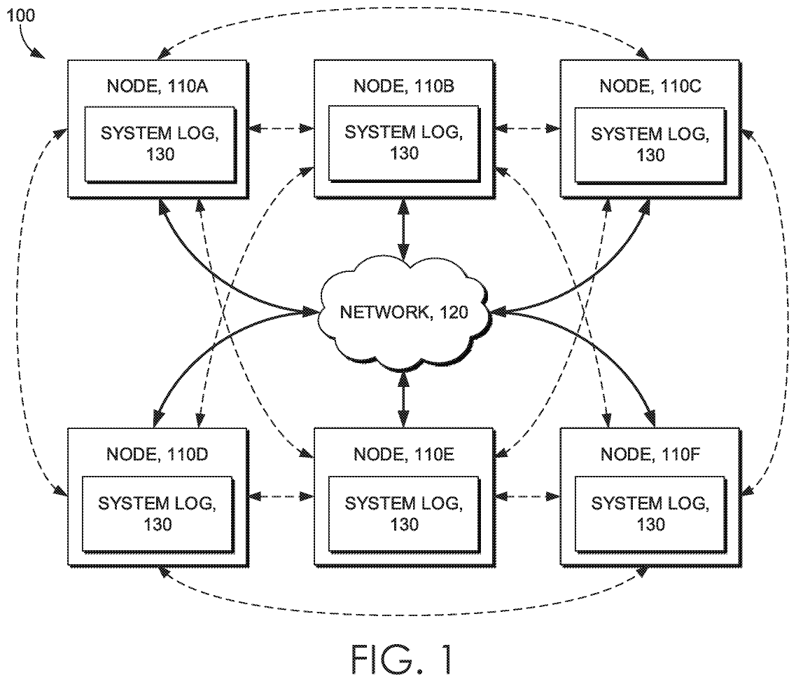

Turning now to FIG. 1, a schematic depiction is provided illustrating an example distributed ledger network 100 in which some embodiments of the present disclosure may be employed. It should be understood that this and other arrangements described herein are set forth only as examples. Other arrangements and elements (e.g., machines, interfaces, functions, orders, groupings of functions, networks, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory. Although the distributed ledger network 100 includes a specific quantity of nodes (110A-110F) it is understood that any suitable quantity can exist (e.g., dozens, hundreds, etc.)

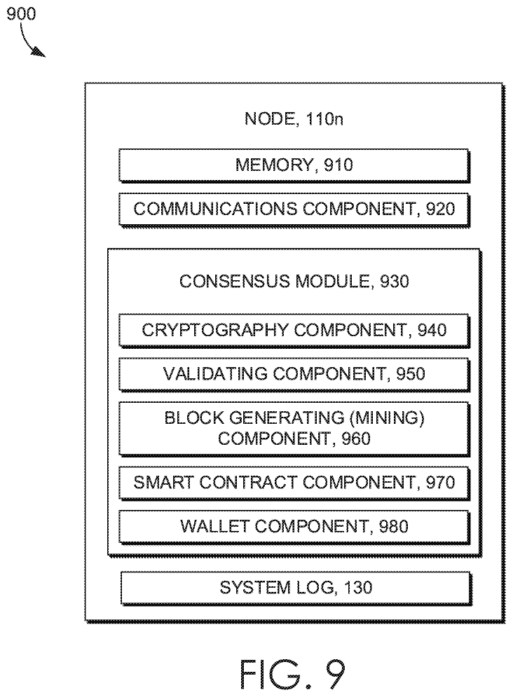

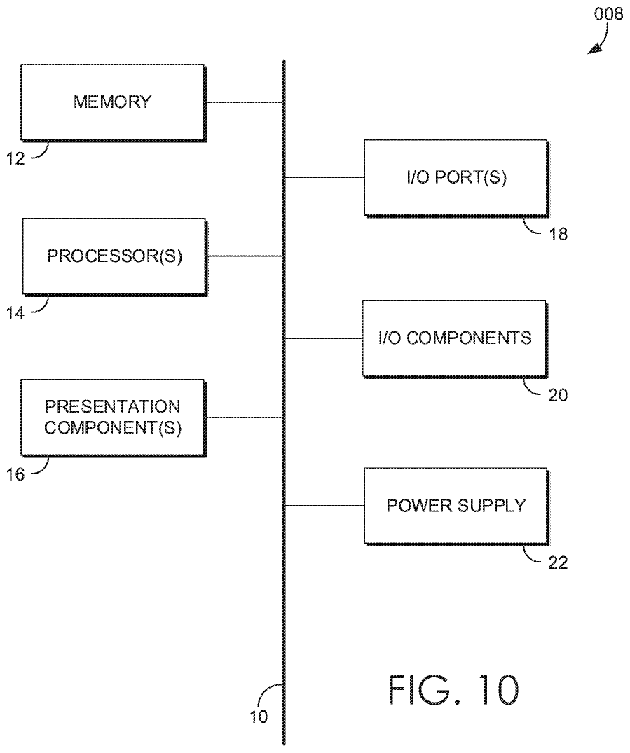

The distributed ledger network 100 depicted in FIG. 1 includes a plurality of nodes 110A-110F that are each in communication with one or more nodes 110A-110F over a network, such as the Internet. In accordance with the present disclosure, each node 110A-110F is a node of a distributed ledger network, as later described in accordance with FIG. 9, which is also a computing device later described in accordance with FIG. 10. In some embodiments, and preferably for public Blockchain implementations, each node 110A-110F in the distributed ledger network 100 can operate as a peer to every other node 110A-110F of the distributed ledger network 110 such that no single node 110A-110F is more influential or has greater privileges than any other node 110A-110F. Accordingly each node may include the same or similar options and/or the same data (e.g., the system log 130). Operations performed by nodes can include, among other things, validating transactions (e.g., a request to add an access event to the system log 130), verifying blocks of transactions, and adding records to an immutable database that is collectively maintained by the nodes 110A-110F. It is contemplated, however, that in some embodiments, a particular subset of the nodes 110A-110F can be specifically designated for performing a subset of or all node operations described herein. In this regard, as opposed to embodiments where each node is a peer with other nodes, some embodiments can employ specially-“designated nodes” (preferably for private Blockchains or ecosystems where centralization is not a concern) that perform a subset of or all of the described node operations.

In accordance with embodiments described herein, the immutable database collectively maintained by the nodes 110A-110F is referenced herein as a Blockchain. The Blockchain maintained by the distributed ledger network 100 includes a plurality of records that are immutable or append-only (i.e., can only be written to and not modified) by virtue of the distributed nature of the distributed ledger network 100, applied cryptography concepts, and a consensus module (see e.g., FIG. 9) that is independently included and operated by any number of nodes 110A-110F. While any node can generate a transaction (e.g., request to log an access event or request to modify a log) to be added to the Blockchain, the consensus module requires that the record or block be added to the Blockchain only based on a determination that a consensus (e.g., greater than 50%) of the nodes 110A-110F (or designated nodes) has collectively validated the transaction. In this regard, while each node 110A-110F can independently store a copy of the Blockchain, a record can only be added to the Blockchain when a consensus to add the record has been reached by the nodes 110A-110F (or designated nodes) of the distributed ledger network 100.

In various embodiments, validation of a transaction is facilitated utilizing features of asymmetric key cryptography (i.e., public-private key pairs), among other things. In some aspects, as is commonly known in public Blockchains (e.g., Bitcoin), a private key can be employed to generate one or more associated public keys, encrypt data (e.g., system log access events) that can only be decrypted by an associated public key, and/or digitally sign data or transactions. On the other hand, a public key can be employed to decrypt data encrypted by an associated private key, encrypt data that only the private key can decrypt, and/or digitally authenticate a digital signature generated by an associated private key. As public keys can be shared freely, public keys generally function as “wallet addresses” that are associated with a private key. In this regard, digital tokens or other units of value (e.g., log file access events) can be “transmitted” from one wallet address (i.e., a public key of a sender) to another wallet address (i.e., a public key of a receiver). In actuality, however, the transmission of a digital token or unit of value is not a physical transfer, but is represented as a record of transfer from one wallet address to another that, if validated, is recorded onto the blockchain. The record is not finalized (i.e., added to the Blockchain), however, until the transfer is validated by a consensus of the nodes 110A-110F in the distributed ledger network 100.

To generate a transaction to transfer a digital token(s) or value, the owner of the sending wallet address (e.g., an organization network server device or user device) must digitally sign the transaction with the private key associated with the sending wallet address. Nodes 110A-110F (or designated nodes) of the distributed ledger network 100 must independently determine that the transaction from the sending wallet address is valid (or invalid) by digitally authenticating the digital signature (or not authenticating) with the sending wallet address (i.e., the public key). The nodes 110A-110F (or designated nodes) must also independently determine, by referencing their independently-stored copy of the Blockchain, that the sending wallet address is in fact associated with the digital token being transferred, or that the sending wallet address has sufficient liquidity (i.e., has a calculated aggregate value based on associated records in a local copy of the Blockchain) to transfer the unit(s) of value, such as log access events. If a node (or designated node) in the distributed ledger network 100 determines that either of the foregoing conditions is not satisfied, the transaction is determined invalid by the node and the transaction is not passed on (e.g., communicated) to other nodes (or designated nodes) to which it is connected. On the other hand, if the node (or designated node) determines that both of the foregoing conditions are satisfied, the transaction is determined valid and the node passes on (e.g., communicates) the transaction, along with an indication that the node independently validated the transaction, to other nodes 110A-110F (or designated nodes) to which it is connected. As the nodes 110A-110F in the distributed ledger network 100 are all directly or indirectly connected to one another, this validation process continues until the nodes (or designated nodes) collectively determine that a majority (i.e., consensus) has validated the transaction. The collective determination of consensus can be facilitated by virtue of each node (or designated node) maintaining a list of other nodes (or designated nodes) on the network (e.g., by I.P. address or other identifier) along with their respective determinations of transaction validity.

In an example illustration of “validation,” a user, such as an employee, may engage in performing a particular database operation (e.g., a delete of a database record) on a corporate network. Responsively, and as a background task (i.e., without user interaction), a service or enterprise associated with the employee (e.g., node 110A) may encrypt the database operation access event before requesting to the nodes 110B-110F to add the database operation access event to the log file or end of the blockchain. In response to the receiving of the encrypted access event, one or more of the nodes 110B-110F can digitally sign and/or decrypt the encrypted access event as part of the “validation” process as described above.

After a consensus of validity for a transaction has been reached by the nodes 110A-110F (or designated nodes), the transaction awaits confirmation (i.e., addition to the Blockchain). As the nodes 110A-110F (or designated nodes) can be peers with each other, any node (or designated node) can participate in the process of adding the transaction to the Blockchain. For purposes of background, the Blockchain includes records of validated transactions (e.g., sequential access events that are added to a log file) that are grouped into a cryptographically chained series of blocks, whereby each block includes a subset of these records. For example, each block in the Blockchain can represent a different timestamped access event that together form the contents of an audit trail or system. In other embodiments, however, each block can contain two or more access events and include other information (e.g., transaction tokens). An “access event” as described herein is any command, request, input, selection, and/or any other suitable action performed by a user device on a particular network. An access event can be any input received on a user device where network resources are utilized or accessed (e.g., files, firewalls, configuration of servers, etc.). For example, an access event can be or include: keystrokes, selections (e.g., mouse clicks, touch pad selections, etc.), login attempts or engaging in a network session (e.g., entering credentials to open up an enterprise network, opening a browser application to browse on the internet, inputting different URLs, etc.), downloading or installing a file or application, performing a database operation (e.g., READ, DELETE, INSERT, etc.), modifying a file or application, and/or accessing a file or application, etc. An access event as described herein not only includes the completion of some event (e.g., completing a download of an application) but also includes the initiation of the event where the event was not completed (e.g., starting the download of an application, which ultimately results in a failure to download). Accordingly, initiation of access events may be written to a log file or Blockchain. In various embodiments, access events also include any user action that is “privileged” according to PAM infrastructure.

Any node 110A-110F (or designated node) can perform the process of block generation, which can be implemented in a variety of ways based on a consensus algorithm implemented within its consensus module including, but not limited to, proof of work, proof of stake, proof of authority, practical Byzantine Fault Tolerance, or Federated Byzantine Agreements. As the aforementioned processes for block generation are generally known in the art, additional detail for these processes are not described herein. It is contemplated, however, that any implementation of block generation and consensus determination can be employed in accordance with the present disclosure. More importantly, as the general outcome of block generation is relatively similar among these implementations, the following description is provided irrespective of the block generation aspect of the consensus module.

To add a validated transaction to the Blockchain (e.g., an access event to a log file), the transaction must first be included into a block that is being generated by one of the nodes 110A-110F (or designated nodes) and subsequently validated by a consensus of the nodes (or designated nodes) in the distributed ledger network 100. The transaction can be independently included into a block, or grouped together with other transactions, either of which are included within the purview of the present disclosure. Such implementations may vary, however, based on consensus module design and/or a block size (i.e., memory limitation) implemented or defined within in the consensus module operated by the nodes 110A-110F (or designated nodes). The node generating the block also includes, into the block it is generating, a cryptographic hash of the block most-recently added to the Blockchain (e.g., a most recent access event according to a timestamp). Once generated in accordance with consensus rules defined within the consensus module, the node generating the block can send the generated block to the nodes (or designated nodes) to which it is connected.

The nodes (or designated nodes) receiving the generated block can then verify that the block includes one or more valid transactions, includes a hash value of the block most-recently added to the Blockchain, and was generated in accordance with the defined consensus rules. Upon verifying the foregoing, the nodes (or designated nodes) can pass on (e.g., communicate) the verified block to its neighboring nodes (or neighboring designated nodes). In this way, similar to how a transaction is validated by a determined consensus of the distributed ledger network 100, the generated block including at least the transaction can be verified by another determined consensus of the nodes (or designated nodes). When a determination is made by a consensus of the nodes 110A-110F (or designated nodes) that a block is verified (e.g., that an access event temporally follows the other access events), the newly-verified block is added to the Blockchain immediately subsequent to the previously-added block, the hash of the previously-added block being included in the newly-verified block. As such, each block is cryptographically “chained” to a previous block and a subsequent block. In other words, the cryptographic hashes facilitate maintenance of the order and accuracy of records included in the Blockchain.

In some instances, if the same transaction is included into a block generated by different nodes (or designated nodes) and validated throughout the network within a substantially similar timeframe, the blocks can be temporarily confirmed leading up to a fork in the Blockchain (e.g., two potential branches stemming from the main chain). The forked chain can be maintained by the nodes (or designated nodes) until a determination is made, by a consensus of the distributed ledger network 100, that one of the forks has a larger quantity of blocks than the other. Based on a subsequent determination that one of the forks is shorter than the other, the nodes (or designated nodes) can prune (e.g., delete) the shorter chain, and maintain the longer chain as the determinative Blockchain.

In various embodiments, the Blockchain is not necessarily limited to storing records relating to transfers of digital tokens or monetary value. In this regard, a record can include any type of electronic record, including but not limited to one or more access events, transactions, electronic documents, images or other digital media, URIs, alphanumeric text, unique identifiers, I.P. addresses, timestamps, hashes of any of the foregoing, or references to any of the foregoing. Any of the foregoing examples can be viewed as being the subject of a transaction, or can be indirectly associated with a transaction.

As illustrated in FIG. 1, the system log 130 are stored to each of the nodes 110A-110E. n some embodiments, however, the system logs are not stored on each of the nodes in a network, but only some of the nodes. A “system log” as described herein includes a file of a series of historical recorded access events (e.g., mouse clicks, web searches, downloads), often time-stamped, and which are not viewable, except by an administrator. A system log in various embodiments does not contain any other information other than a history of past user actions and associated metadata. In an example illustration of system log privileges, a user may download a first file and try to erase the file. However, the log entry or access event that indicates the user downloaded and erased the file is not deleted in the system log. Such user may not be an administrator and thus may not have access privileges to access the system log. System logs are thus append-only data objects. Aspects of the present disclosure describe that system logs are also append-only data objects even for privileged users such as administrators according to embodiments described herein. System logs can record, as a background task, all or selected (e.g., verified blocks) events that occur in an operating system in particular embodiments. In various embodiments, each access event recorded in a system log corresponds to each block of a blockchain. Accordingly, in particular embodiments, the access events are not added into the system logs until they are verified, as described above with respect to FIG. 1, which is different than typical system logs, which automatically record every action without validation.

Each of the system log 130 are identical copies of an access event Blockchain. As described above, in order to validate a request to add another access event to the end of the Blockchain, each or a consensus of the nodes 110A-110F must validate the request against their own copy of the system log 130. For example, each access event or block of each copy may be linked together via a hash that points back to the timestamped block or access event that occurred immediately before it. Accordingly, if a request is received to add an access event and a determination is made that timestamp associated with the request is later in time than any of the other blocks and no modification of past blocks are requested, the request may be validated. Alternatively, if a request is received associated with changing an access event that has already been timestamped, the request may be invalidated, as the timestamped events in the majority of the other nodes do not match.

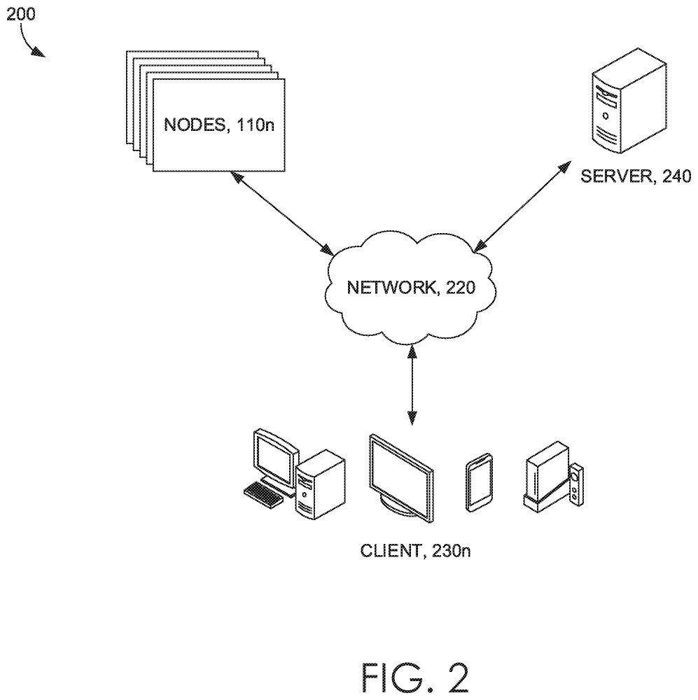

Referring now to FIG. 2, a schematic depiction is provided illustrating an exemplary system 200 in which some embodiments of the present invention may be employed. It should be understood that this and other arrangements described herein are set forth only as examples. Other arrangements and elements (e.g., machines, interfaces, functions, orders, groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The system 200 can include, among other things, a distributed ledger network 200 comprising a plurality of nodes 110n as described with reference to FIG. 1, each in direct or indirect communication with one another via a network 220. It is contemplated that the nodes 110n can include a subset of designated nodes authorized to perform specifically-designated operations, such as validation, verification, or block generation, among other things (e.g., as described with reference to the nodes 110 of FIG. 1). The system can also include one or more client devices, such as client 230, 230n (e.g., user devices, such as desktops, mobile devices, tablets, etc.). It is contemplated that any one or more nodes 110n can be a client 230, 230n, and one or more clients, 230, 230n can be a node in accordance with embodiments described herein. In this regard, nodes 110n and clients 230, 230n are computing devices also described herein in accordance with FIG. 10 and/or 9.

In one aspect, a client 230, 230n (and/or server 240) can include the consensus module (e.g., consensus module 930) similarly included in other nodes 110n (or designated nodes) within the distributed ledger network 200. In another aspect, the client 230, 230n can generate transactions that can initially be validated locally and/or by the server 240 (e.g., a corporate network server), via the consensus module included therein, before the transaction is passed on to other nodes. In another aspect, a client 230, 230n can be in communication with one or more nodes 110n via the network 220, and can locally generate a transaction for communication via the network 220 to one or more nodes 110n that the client 230, 230n is in communication with. In this way, the one or more nodes 110n (or designated nodes) receiving the transaction directly or indirectly from the client 230, 230n can validate the transaction in accordance with the present disclosure.

In some aspects, any node 110n can operate as a node that includes the consensus module, and any client 230, 230n can operate as a client device that can: transmit communications to one or more nodes 110n, generate transactions, and receive communications (e.g., transaction status, Blockchain data) from one or more nodes 110n. For purposes of simplicity, the following description will reference a client 230, 230n as a node 110n, though embodiments are not limited as such.

In some embodiments, the system 200 can further include a server device, such as server 240. The server 240 can be in communication with one or more nodes 110n to send generated transactions to the one or more nodes 110n, request and receive transaction status information from the one or more nodes 110n, and/or request and receive Blockchain data from the one or more nodes 110n, among other things. In some further embodiments, server 240 can include can include one or more computing devices, also described in accordance with FIG. 9 and/or 10, whereby the one or more computing devices include a consensus module to operate as a node 110n (or designated node). Among other things, the server 240 can further provide or host one or more services, such as enterprise services (e.g., shared drive storage, instant chat, email functionality, etc.) data storage services, web hosting services for one or more websites, user authentication services, certificate authentication services, backup services, data mining services, “cloud”-stored data or web search services, block explorer services, analytics services, and/or the like, including any combination thereof.

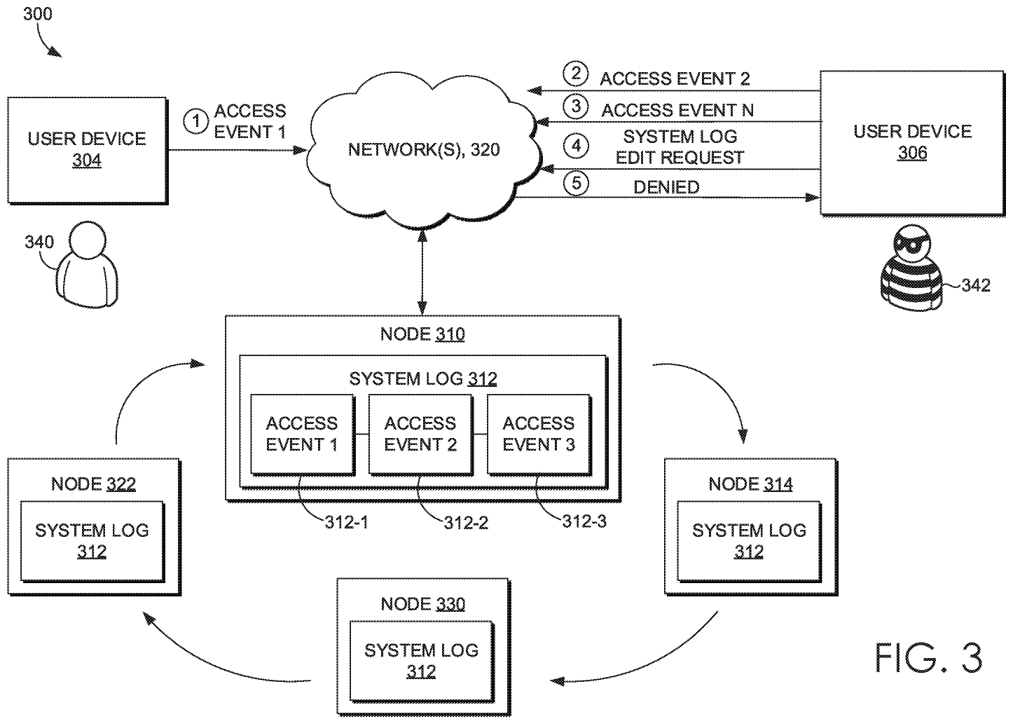

FIG. 3 is a block diagram of a computing environment 300 associated with logging access events, according to particular embodiments. In various embodiments, the environment 300 is or is included in the systems 100 and/or 200 of FIG. 1 and FIG. 2 respectively. Accordingly, in some embodiments, the user device 304 and/or user device 306 represent the client devices 230n and vice versa. Likewise, in some embodiments, the nodes 310, 314, 330, and 322 represent the nodes 110A-110F of FIG. 1 and/or the nodes 110n of FIG. 2. In some embodiments, one or more of the nodes (e.g., node 310) represents the server 240 as described in FIG. 2. Although FIG. 3 is described with respect to a specific quantity of components (e.g., 2 user devices, 4 nodes), it is understood that any suitable quantity may exist. For example, in some embodiments, only one user device exists (e.g., user device 306) without the other user device. In some embodiments the system log 312 is included in blockchain blocks, as opposed to encompassing each block of a blockchain as illustrated in FIG. 3. For example, in some embodiments, the system log 312 is only a sub-part of a larger framework of transactions in a blockchain (e.g., smart contracts, BITCOIN, etc.). Accordingly, for example, each block may not only include a log file (or hash of a log file) but include other token-related information, such as transactional data associated with the transfer of coins or other units of value.

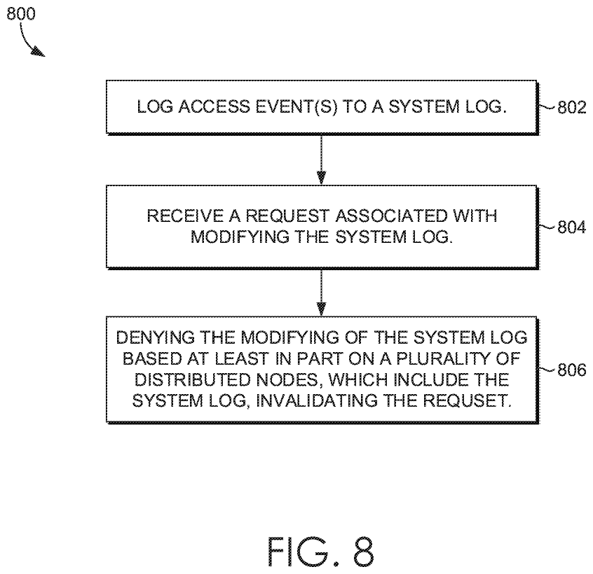

FIG. 3 illustrates the user 342 unsuccessfully trying to modify the system log 312. FIG. 3 also illustrates how the system log 312 is generated according to distributed network principles of some embodiments. At a first time a particular user 340 (e.g., an employee with a particular degree of privileged access) provides input to the user device 304. For example, the input can be logging on to a corporate network, which the user 340 may have privileges to do. In various embodiments, each user input, as a part of or while on an enterprise network, is transmitted over the one or more networks 320 (e.g., to the node 310), as a background task as a request to add an associated access event to the system log 312. A “background task” as described herein is or includes any automated task, operation, thread, or function that occurs without an explicit user request (e.g., a user typing or selecting a GUI button) to perform such task, operation, thread, or function. For example, in response to the user 340 downloading a particular application, an automatic request is transmitted and received by one or more of the nodes 310, 314, 330, and/or 322 to add the download (access event 1) as a block to the system log 312. However, the user 340 does not make such explicit request to add this access event 1 as a block of a blockchain to the system log 312. In some embodiments, however the access event is automatically added to a system log, as described with reference to block 802 of FIG. 8.

Some or each of the nodes 310, 314, 330, and 322 then engage in the process of validating access event 1, as described in detail with respect to FIG. 1 above. Each or a consensus of the nodes 310, 314, 330, and 322 determine that the access event 1 is valid. Accordingly, the access event 1 and/or any other associated information (e.g., metadata, such as timestamped information of a completion of the access event) is added to the system log 312 as a block 312-1 in a Blockchain, as illustrated in each of the nodes 310, 314, 330, and 322. Although the system log 312 is represented as the same component within the nodes 310, 314, 330, and 322, it is understood that the same identifier is used only to show that the contents of the system log 312 is the same. However, each system log 312 within each node may in fact be a separate unique copy of the same contents.

At a second time, subsequent to the first time, the user 342 engages in the process of covering his tracks by accessing particular resources or actions and trying to modify system logs. Specifically, the user 342 first provides some particular input to the user device 306, which is indicative of an access event. For example, the user 342 may be a privileged administrator that performs the access event of logging into a financial database within an organization. In response to this login, access event 2 is transmitted, as a background task and over the network(s) 320, to one or more of the nodes 310, 314, 330, and 322. FIG. 3 illustrates that the access event 2 is then validated and added to the system log 312 as a block 312 within each of the nodes 310, 314, 330, and 322. Specifically, it is linked to the block 312-1 associated with access event 1. The linking of blocks are described in more detail herein. The user 342 may then, at a third subsequent time, engage in another access event(s) N, which is also validated. For example, the referring to the illustrative example above, the user device 306 may display a particular relation or table of the financial database that was logged into at access event 2. The user 342 may then perform some database operation on the table, such as changing a value to a record of financial data. This access event (access event N) may then be transmitted, as a background task, to the node(s). FIG. 3 illustrates that access event N is added or linked as a block 312-3 to the end of block 312-2.

At a fourth subsequent time, however, the user 342 may engage in the process of requesting to edit the system log in order to delete access events 1 and 2 from the system log 312. For example, using the illustration above, the user 342 may have input a higher value of money into the financial database table record corresponding to the user's 342 compensation such that the user 342 is trying to elicit more compensation when it becomes due to him. Accordingly, the user 342 may try to cover his tracks by deleting the access events 2 and N from the system log 312 so that an audit of the logs will not reveal that the user 342 ever queried the financial database. As described above, existing technologies allow those with particular privileged access to modify these system logs, which is a large vulnerability for many organizations. However, in this situation, even those with super privileges will not be able to modify system logs because of the distributed ledger network principles described herein. Specifically, the user device 306 issues a request to modify the system log 312 (e.g., by deleting access events 1 and 2). However, as described above, by nature of the distributed nature of distributed network ledgers, the system logs are append-only, meaning that blocks cannot be modified (e.g., erased, written to) in any way.

For example, although the user 342 may access his corporate server (e.g., node 310) to modify the system log 312 on the corporate server, the corporate server may not allow such modification because the other nodes 314, 330, and 322 or a “consensus” of the nodes will include different copies of the system log 312 than the contents requested by the user device 306. More specifically, the user device 306 may be requesting to delete access events 2 and N. Accordingly, the request would now attempt to cause a link of block 312-1 associated with access event 1 to another block or a request that causes block 312-1 to be the last block. However, because each system log 312 copy in each node indicates which specific access event blocks are preceded and followed by other blocks, any attempt or request to alter this sequence will cause the nodes or a consensus of the nodes to invalidate such request. Accordingly, the system log edit request originating from the user device 305 is denied.

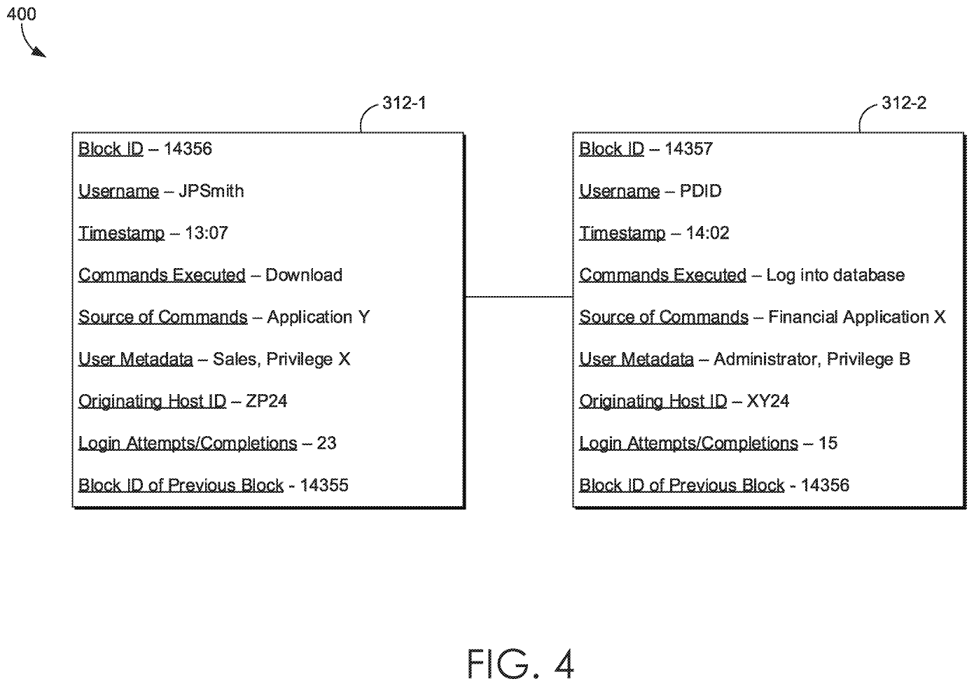

FIG. 4 is a schematic diagram illustrating the contents of the blocks 312-1 and 312-2 of FIG. 3. Although FIG. 4 illustrates specific blocks 312-1 and 312-2, it is understood that analogous contents can be included in any block described herein, such as block 312-3 of FIG. 3. It is also understood that any block or record described herein can include some or all of the information illustrated in each of the blocks 312-1 and 312-2. For example, in some embodiments, block 312-1 does not include “username” or “login attempts/completions” identifiers. In some embodiments, some or all of the information contained in the blocks 312-1 and 312-2 is only a sub-unit of information contained in blockchain blocks. Accordingly, this information may represent a system log that is also included with other unrelated information, such as other distributed ledger network functionalities, such as BITCOIN or other blockchain functionality (e.g., a smart contract). For example, the block 312-1 may also include coin transaction data specifying who passed coins to whom, anonymized payments, hash of screen recordings, etc.

Blocks 312-1 and 312-2 both include block IDs, which is an identifier that identifies the block that contains the corresponding contents. Both blocks 312-1 and 312-2 include a username identifier, which may correspond to an enterprise username identifying a user (e.g., users 340 and 342) associated with a device that engages in the associated access event(s). Such user in various embodiments has privileged access to a network at some particular level. The username may be a username that a user utilizes in order to log into an enterprise system, such as a corporate LAN. The blocks 312-1 and 312-2 also include a “timestamp” identifier, which specifies a clock-time at which an access event was initiated, completed, and/or a request associated with the access event was received (e.g., by the node 310).

The blocks 312-1 and 312-2 also include a “commands executed” identifier. This identifies each command that the user device issues on a network, such as a “download” of an application or “log into a database.” In various embodiments, this identifier specifies each command that was executed using privileged access from the associated users (e.g., JPSmith). Accordingly, this identifier corresponds to identifying the particular access event that a user device has engaged in, as described herein. Each of the blocks 312-1 and 312-2 also include a “source of commands” identifier, which corresponds to describing what platform, operating system, application, and/or host the commands were executed within or in connection with. For example, JPSmith may have executed a “download” of “Application Y,” which is the “source” of the download commands.

The blocks 312-1 and 312-2 also include “user metadata,” which identifies any suitable metadata associated with a user and/or user device of the user. For example, the user metadata in various embodiments includes the job role or title of an employee (e.g., JPSmith and PDid), such as “sales” or “administrator.” Each privilege may also be identified that each user has under user metadata, such as specifying the user has network administrative access and/or read/write capabilities of a particular subset of identified applications. The blocks 312-1 and 312-2 also include “login attempts/completions” identifiers, which describe when user devices either successfully login (e.g., provide authenticated and authorized username and password to log into a network) and/or unsuccessfully login (e.g., provide the wrong password). This identifier may not only specify the quantity of login attempts and/or completions, but specify what source the user was trying or did log into (e.g., a financial database).

The blocks 312-1 and 312-2 also include the block ID of the previous block before it. For example, block 312-2 points to or identifies that the previous block before it is block ID 14, 356, which is the same value as indicated in the block ID identifier of block 312-1. In various embodiments, validation of transactions or requests for any given node includes identifying each “block ID” and each “block ID of previous block,” in order to ensure that the chain or sequence is not altered in any way. For example, if a privileged access user tried to modify a system log by deleting the block 312-1, the “block ID of previous block” identifier would be requested to be some character sequence other than 14356. Accordingly, because a consensus of nodes may include a copy of the system log that identifies the “block ID of previous block” as 14356, and not any other identifier, the request would be invalidated.

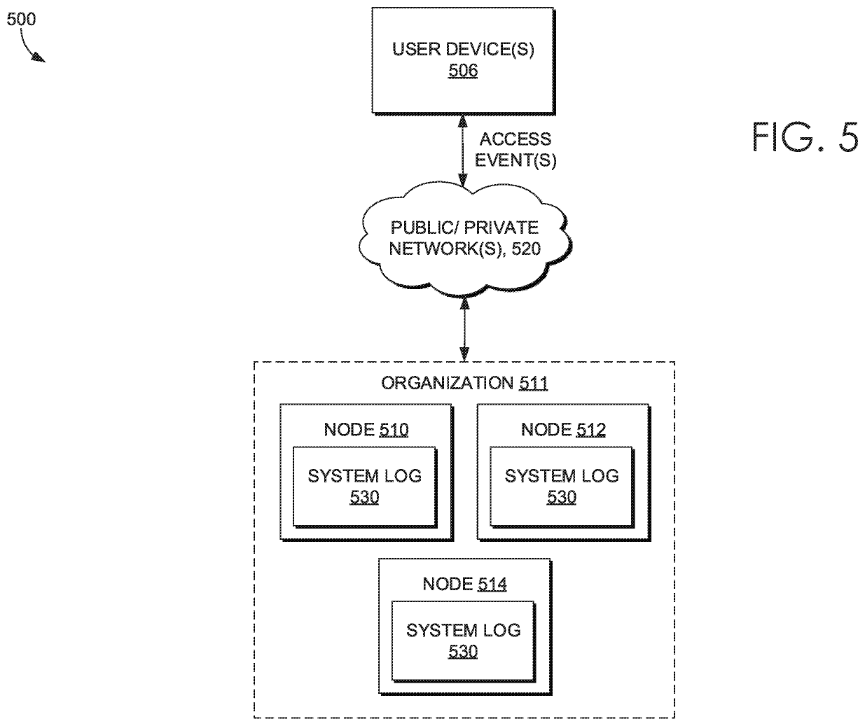

FIG. 5 is a block diagram of a public or private network system 500, according to embodiments. In various embodiments, the public or private network system 600 is or is included in the system 100, 200, and/or 300 of FIGS. 1, 2, and/or 3 respectively. In some embodiments, the system 500 is a public system or blockchain (and not a private system or blockchain). A “public” system or blockchain as described herein provides a strongest level of protection against tampering with the system log 530. This may be because in public systems, system logs can be spread over more nodes and over a wider area (e.g., across computing devices of the public internet) than private blockchains. Accordingly, the organization 511 in various embodiments represents an entire public network of nodes that store access events, such as the internet, as opposed to a single entity or enterprise. This makes it harder for users to pinpoint what nodes may have the log files and may take more time to locate each node, since there may be many more nodes to locate. However, because the system log 530 includes access events, which are sensitive in nature, access events are preferably protected through one or more mechanisms (e.g., encryption and/or hashing) on public systems according to particular embodiments.

In some embodiments, privileged user access events are written to a blockchain in an encrypted format (e.g., utilizing the methods, as described with respect to FIG. 1), such that only people or devices with access to the private key can read the privileged access events or system log 530 in public systems. Additionally or alternatively, in some embodiments hashing is utilized. In these embodiments, only a hash of the privileged user access event is written to the system log 530. In this manner, there is no plain text of an access event within any blockchain block. That is to say that the system log 530 itself is not written or stored on the blockchain. Rather, the hashes only are written to blocks. The hash confirms whether the privileged user system log 530 has been tampered with in accordance with hashing algorithms as described herein. In these hashing embodiments, backups of the system log 530 can be mirrored or copied to other databases, and the hashes on the blockchain confirm which copy is legitimate. In an example illustration of this functionality, a data structure associated with the blockchain may include a mapping of a hash of the system log 530, as it is included in a blockchain, to the actual plain text system log 530 as it is included in the mirrored database. In this way, legitimate copies can be confirmed.

In some embodiments, writing only the log hashes allows a wide range of public blockchain infrastructures to be utilized in combination with storing the hashes of the system log 530. For example, public blockchains, such as BITCOIN, can be used in combination with the methods described herein. For example, referring back to FIG. 4, in some embodiments, some or each of the blocks 312-1 and 312-2 additionally include other information, such as a payload that describes token or bitcoin transactions between parties (e.g., C pays A for a first block, B pays C for a second block). In these embodiments, the hash can be written to one or more fields, such as a metadata field of the token transaction (e.g., using the IP_RETURN filed in BitCoin) or a destination wallet address (in cryptocurrency blockchain) using a zero or nominal transfer amount.

In some situations on public systems or blockchains, there is a transaction fee associated with the blockchain. In these situations, the origin (e.g., an identity of a person or device) that sent or received the transaction payment can be anonymized or obfuscated. Otherwise, the payment in some cases can be used to determine the origin of the privileged user access event. Accordingly, even if the system log 530 is encrypted, the origin and timing of the privileged user access event could still be used by an attacker to infer sensitive information. Therefore, in various embodiments, payments and origins of payments are anonymized or obfuscated. Data anonymization refers to computing mechanisms that are used to remove and/or obfuscate one or more attribute values such that resulting views can no longer be used to identify a name of an individual or associate an individual to sensitive information. In some embodiments, anonymizing payments include using temporary wallets or wallet addresses to pay transaction fees. In some embodiments, anonymizing includes using cryptocurrency tumblers to generate anonymous tokens, coins, or other units of value. A cryptocurrency tumbler is a function that mixes potentially identifiable cryptocurrency funds with other funds so as to obscure the trail back to the fund's original source. In this way, financial transactions are mixed together to make it difficult to trace the origin of the funds. In some embodiments, other built-in services or functions are utilized for anonymization, such as ZEROCOIN and MONERO.

In some embodiments, the system 500 is only a “private” network or blockchain (and not a public network or blockchain). A private system in some embodiments is a network that resides solely within an enterprise or organization. Accordingly, for example, each of the nodes 510, 512, and 514 may each be servers and/or other computing devices (e.g., company desktops) within a corporate data center, local network, and/or cloud of an organization, etc. Effectively, each of the nodes 510, 512, and 514 can represent any computing device that has access privileges or connects to the private network (e.g., private network 520). This is unlike public networks, where system logs can be spread across the internet on different nodes. Rather, in these embodiments, the system logs 530 are only distributed within a private network, such as only devices connected to an enterprise network. An “enterprise network” as described herein is or includes a local area network (LAN) of an organization and/or a wide area network (WAN) that links computing devices within offices or other building structures of an organization around the world. These private networks have the advantage of limiting access to the system logs 530 because the logs 530 can mostly only be accessed by individuals within the organization 511. In some embodiments, because the system logs 530 are only written to nodes within an enterprise in private systems, the system logs 530 are not encrypted or hashed, unlike the system logs within a public network. However, a private blockchain can be more susceptible to corruption than a public blockchain because an attacker need only take control or hack into a majority of nodes within a single organization. Accordingly, as described above, when it comes time to “validate” a transaction by a “consensus” of the nodes, if the attacker managed to hack into the majority of the nodes (which would be easier if nodes were limited to an organization), the attacker may have a higher likelihood of modifying logs. Accordingly, it may be desirable to spread system logs over a higher quantity of nodes within an organization (i.e., the organization network should be highly distributed) or a public network may be more desirable.

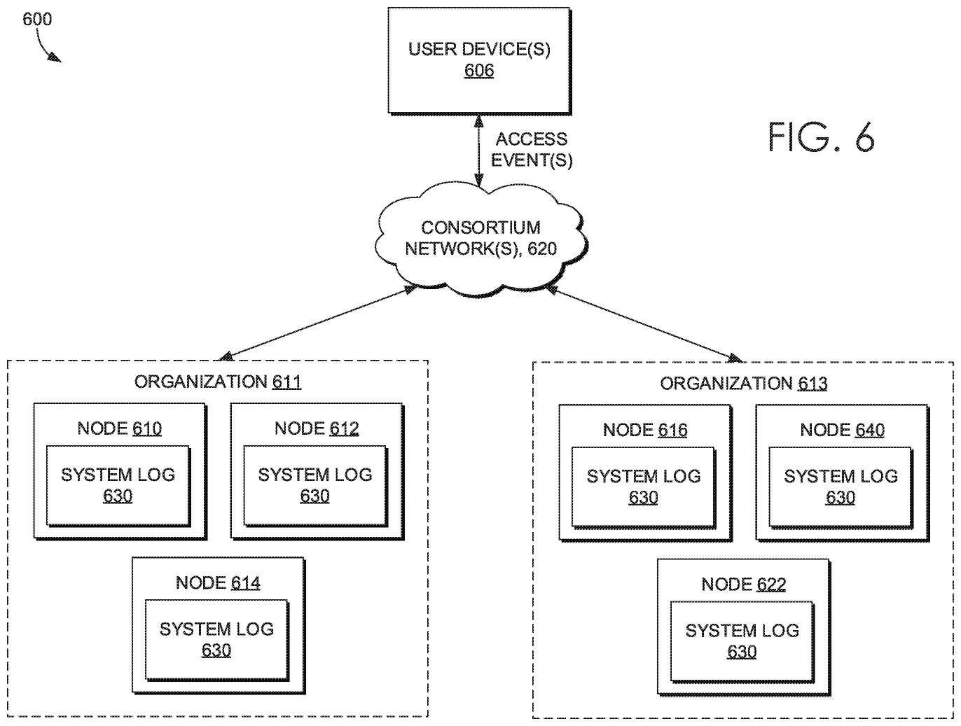

FIG. 6 is a block diagram of a consortium system 600, according to embodiments. In various embodiments, the consortium system 600 is or is included in the system 100, 200, and/or 300 of FIGS. 1, 2, and/or 3 respectively. The consortium system 600 includes blockchain nodes that are distributed across different organizations or enterprises. The nodes 610, 612, and 614 (two of which include a copy of the system log 630) all belong to the same organization 611. For example, the nodes 610, 612, and 614 may all be server computing devices within a corporate data center of the organization 611. In another example, these nodes may correspond to the organization 611′s cloud infrastructure Likewise, the nodes 616, 640, and 622 all belong to the same organization 613. As illustrated in FIG. 6, even though there is only one system log 630, copies of the system log 630 are transmitted and distributed to different nodes within two different organizations 611 and 613. For example, the organization 611 may be a corporation and the organization 613 may be a vendor of the corporation. It may be desirable to spread the system log 630 over various nodes of different organizations in order to combine the advantages of both private and public system, as described herein with respect to FIG. 5. Accordingly, tamper resistance of log files is higher than a private blockchain because a user is unlikely to locate system logs on multiple nodes of multiple organizations, compared to only one organization with a private blockchain. However, tamper resistance may still not be as strong as public systems because in public systems system logs can be spread over more nodes and over a wider area than private or consortium blockchains. This makes it harder for users to pinpoint what nodes may have the log files and may take more time to locate each node, since there may be many more nodes to locate.

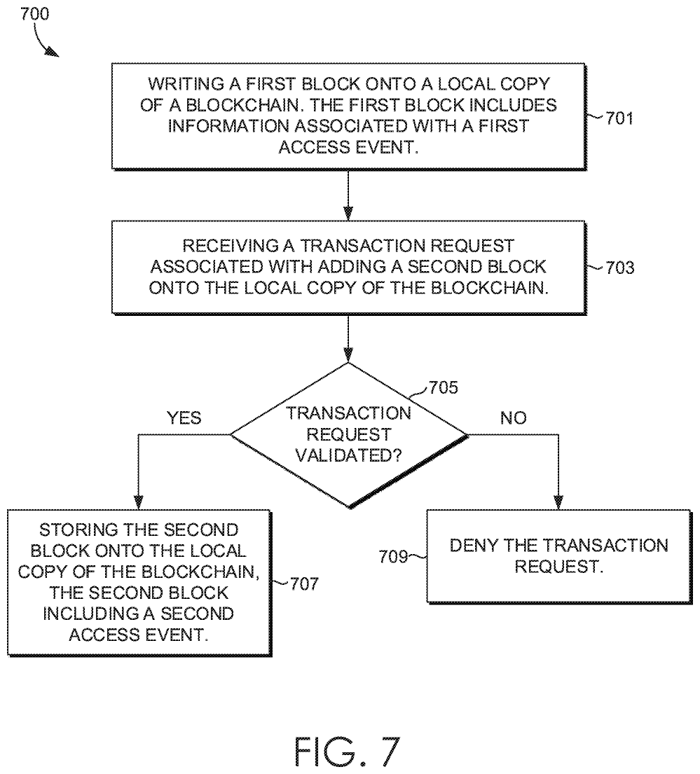

FIG. 7 is a flow diagram of an example process 700 for adding blocks onto a blockchain with respect to access events, according to particular embodiments. The process 500 (and/or any of the functionality described herein (e.g., process 800)) may be performed by processing logic that comprises hardware (e.g., circuitry, dedicated logic, programmable logic, microcode, etc.), software (e.g., instructions run on a processor to perform hardware simulation), firmware, or a combination thereof. Although particular blocks described in this disclosure are referenced in a particular order at a particular quantity, it is understood that any block may occur substantially parallel with or before or after any other block. Further, more (or fewer) blocks may exist than illustrated. Such added blocks may include blocks that embody any functionality described herein.

Per block 701, a first block may be written (e.g., by the node 110A) onto a local copy of a blockchain. The first block includes information associated with a first access event. For example, in response to a consensus of nodes validating an associated transaction request, the first block may be stored to the local copy of the blockchain. The information associated with the first access event in particular embodiments is some or each of the information (or similar information) described in the blocks 312-1 and/or 312-2 of FIG. 4. In some embodiments, the block is a transaction block that includes information indicating a first access event of a system log. For example, referring back to FIG. 3, the information may be the information contained in the block 312-1 of the system log 312. In particular embodiments, the access event indicates a privileged action performed by a user device while initiating access (e.g., logging on) to or connected to a computer network (e.g., downloading files after login). The privileged action corresponds to a user or process having authority to make one or more administrative changes of actions to the computer network or other resource within the computer network. For example, a user (e.g., an administrator) with privileged access may configure a firewall (an access event) on an enterprise network. This access event can then be included in a transaction request to write it to the first block and responsively be stored per block 701.

Per block 703, a transaction request associated with adding a second block onto the local copy of the blockchain is received (e.g., by the node 110A). For example, in some embodiments, the transaction request is or includes a BITCOIN or other token-based request where units of value are requested to be added to a block of a blockchain as described with respect to at least FIG. 1. In some of these embodiments, the second block includes access events or a system log despite the fact that transaction requests are not directly related to the system log. In some embodiments, however, the transaction request is or includes a request to store a second access event to a system log. For example, referring back to FIG. 3, block 701 of the process 700 may correspond to storing the block 312-2 to the blockchain system log 312. In this manner, there may be a one-to-one correspondence between each access event and each block of a blockchain such that each time an access event occurs, requests are generated to create a block only for that access event. In this manner, the blocks only contain information associated with access events and no other information (e.g., BITCOIN transactions). In these situations, the system or blockchain may by a “private” or “consortium” system or blockchain as described herein. For example, nodes may be linked according to the manner described in FIG. 4, since there is no other outside mechanism, such as BITCOIN, to link each block.

Per block 705, it is determined whether the transaction request of block 703 has been validated. For example, referring back to FIG. 1, a consensus of the nodes 110A-110F may validate or invalidate (e.g., stop, block, deny, or halt) the request as described herein. Per block 707, if the transaction request has been validated, the second block is written and stored (e.g., by the node 110A) onto the local copy of the blockchain. The second block may also include the first access event and other access events, such as a second access event and even an entire system log. In particular embodiments, such as those described with reference to ty system log 312 of FIG. 3, the access events are also responsively added to the system log based one at least two or more of the plurality of nodes validating the transaction request.

Per block 709, if the transaction request is not validated, then the transaction request is denied or blocked. For example, a request may be invalidated based on a user trying to modify a system log. The very act of trying to modify a system log may be or be included in a transaction request associated with adding a block to the blockchain. However, because a consensus of the nodes may not agree that the request modification is consistent with their respective local copies of a system log, the transaction request is denied. Alternatively or additionally, the denial of the transaction request is based at least in part on other non-related transaction requests, such as requests to transfer tokens or BITCOINS for example. In an illustrative example, a node may detect that a user does not actually own a coin (e.g., via the cryptography functionality described herein) and/or that a user has already spent the coin (e.g., via “proof of work” functionality). Responsively, the transaction request is denied. Accordingly, the second block is not stored onto the local copy of the blockchain.

FIG. 8 is a flow diagram of an example process 800 for denying a request to modify a system log, according to some embodiments. In various embodiments, the process 800 occurs in response to the process 700 of FIG. 7. Per block 802, one or more access events are logged to a system log (e.g., by the node 110A within the system log 130). In some embodiments, the logging of the access event(s) occur in response to a privileged user performing the access event. In some embodiments, a node (e.g., server 240 of FIG. 2) first automatically (e.g., as a background task) logs the access event in a local copy of a system log. Responsively, the node may then distribute copies of the updates system log to each node (e.g., the nodes 110A-110F of FIG. 1). In various embodiments, each time an access event is logged into a system log on a first node, that first node then transmits a copy of the update to the rest of the nodes for validation purposes as described herein. In some embodiments, the logging at block 802 includes not merely and automatically logging the access event as described above, but alternatively includes requesting that the log access event be added to a blockchain, as described with reference to FIG. 3. Accordingly, in these embodiments, the logging at block 802 only occurs in response to validation techniques described herein.

Per block 804, a request associated with modifying the system log is received (e.g., by the node 110A of FIG. 1). For example, referring back to FIG. 3, the request may be similar or identical to the “system log edit request” as described therein. The request may be or include a request to modify the system log by deleting access events and related information, altering access events and related information (e.g., deleting the access event and inputting that the user engaged in another access event) or otherwise change any aspect of a system log. In some situations, the user may have administrative privileges to view a system log and may try to also edit the system log according to existing methods. In some embodiments, the request at block 804 is or is included in a transaction request as described herein in order to add a block to a blockchain. Per block 806, the modifying of the system log is denied such that the modification does not occur. The denying may be based at least in part on a plurality of distributed nodes, which include the system log, invalidating the request. For example, referring back to FIG. 1, each of the nodes 110A-110F may compare the contents of their copy of the system log 130 with the request or request copy of a system log. This may include identifying that the request or requested copy of the system log has various block IDs that point to different block IDs compared to the stored local copy. Accordingly, in accordance with the validation methods described herein, the modification is denied.

Turning now to FIG. 9, a block diagram 900 is provided depicting exemplary components of a node 110n (or designated node) in accordance with the present disclosure. The node 110n depicted in FIG. 9 can include, among other things, a memory 910, a communications component 920, and a consensus module 930. The memory 910 can include any type of memory, such as a hardware storage device, random access memory (RAM), a cache, read-only memory (ROM), and the like, including any combination thereof. The memory 910 can be employed to store executable computer code that, when executed by one or more processors of the node 110n, perform operations defined and/or implemented within the consensus module described herein. The memory 910 can also be employed to store data communicated from other nodes 110n, clients 230, 230n and/or servers 240, such as those described in accordance with FIG. 2. The communicated data stored in memory can include, among other things, transactions, one or more blocks of a Blockchain, determinations of validity, determinations of authentication/verification, unique identifiers and/or IP addresses of one or more nodes 110n, and other types of electronic data not limited to the foregoing.

The communications component 920 can include any type of communications device that enables the node 110n to communicate with other nodes 110n, clients 230, 230n and/or servers 240, such as those described in accordance with FIG. 2. Communications can be facilitated utilizing wired or wireless communications, and can employ any short or long-range communications technology including, but not limited to, LANs, WANs, Ethernet, the Internet, WiFi, Bluetooth, NFC, optics (e.g., QR codes, Infrared), Zigbee, radio, RFIDs, and the like.

The consensus module 930 can include any number of components or subcomponents that, together with the memory 910 and communications component 320, enable the node 110n to operate as a peer node (or a peer to other “designated” nodes) in a distributed ledger network, such as distributed ledger network 100 described in accordance with FIG. 1. It should be understood that this and other arrangements described herein are set forth only as examples. Other arrangements and elements (e.g., machines, interfaces, functions, orders, groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

In various embodiments, cryptography component 940 can employ asymmetric cryptography (i.e., public-private key) to perform digital authentication and/or verification operations. By way of example, cryptography component 940 can determine whether a transaction submitted from a public key is digitally signed with a corresponding private key. As a digital signature from a public key can only be valid if digitally signed with the corresponding private key, the cryptography component 940 can be employed by the validating component 950 to verify that the transaction is valid with regards to the sender of the transaction. Without going into further detail, in further embodiments, the cryptography component 940 can generate hashes of data, such as transactions, transaction blocks, or passwords, among other things. Hashes can be employed by the validating component 350 to determine that the data has not been altered from a prior state, based on a comparison of any generated hash(es) of the data in a current state to any generated hash(es) of data in the prior state.

In various embodiments, validating component 950 can also determine whether transactions are valid based at least on whether a transaction of a digital token or value subject to the transaction is associated with the public key associated with the sender of the transaction. That is, a digital token or value can only be transferred if the blockchain shows that it is stored in or associated with the public key of the sender. If the blockchain shows that the digital token was already transferred, then the validating component 950 can determine that the transaction to transfer the digital token is invalid.

In various embodiments, block generating component 960 can generate blocks of transactions that have been validated by all or a consensus of the nodes of the distributed ledger network 100. In some embodiments, a block can be generated by a node if a correct “nonce” is guessed for a set of validated transactions selected by the node for inclusion into a block. This particular process is also called “mining,” and is common to proof-of-work systems. In some other embodiments, a block can be generated by a node if a group of designated nodes are programmed under a Federated Byzantine Agreement, which defines the group of designated nodes as being those that are authorized to generate new blocks. It is contemplated that any technique for block generation by the nodes 110n is within the purview of the present disclosure, and the process of generating blocks is not necessarily limited to one consensus methodology known to one of ordinary skill. If some blockchain systems, such as Ethereum, the generation of a block by a node can generate new tokens (e.g., Ether) for the node responsible for guessing the appropriate “nonce.” However, it is important to distinguish the tokens generated for the particular blockchain employed by the embodiments described herein, and the digital tokens generated for the real-world asset, which are the subject of the present disclosure. Certain blockchains, such as Ethereum, provide a framework where smart contracts can be employed to generate new tokens that are distinguishable from the primary blockchain token (e.g., Ether). With regards to Ethereum, as an example, the Ethereum blockchain is maintained by the nodes to maintain the Ethereum blockchain as a whole, but the Ethereum blockchain can also facilitate the transacting of child tokens (e.g., ERC20 tokens) generated on top of the Ethereum blockchain. In this regard, in some embodiments, a pre-existing and highly secure public blockchain, such as Ethereum, can be employed as a framework on which digital tokens (e.g., ERC20) corresponding to real-world assets can be generated and transferred.

Smart contract component 960 can employ one or more processors (not shown) of the node 110n to execute logic or code programmed into a transaction (e.g., a smart contract) stored on the blockchain. In various embodiments, the smart contract component 360 can determine whether a smart contract's defined conditions precedent have been satisfied. The determination can be performed based on transactions stored on the blockchain, by way of example. As each node receives every validated transaction for storage onto its local copy of the blockchain, the node can analyze an incoming transaction including a smart contract, determine whether past or future transactions include data or triggers that meet the defined conditions precedent, and execute an operation programmed in the smart contract based on the determination that the defined conditions precedent have been meet.

In some embodiments, the node 110 can include a wallet component 980. Typically, the wallet component 980 is included in client devices, such as clients 230n, also operating as a node. Generally speaking, the wallet component 980 can be employed to securely store a private key associated with an entity, generate public keys associated with the private key and also the entity, and also to generate new transactions that are digitally-signed with the stored private key. In some embodiments, the wallet component 980 can monitor a locally or remotely-stored copy of the blockchain for transactions associated with a generated public key, and present a parsed set of transactions that are only associated with the generated public key. The wallet component 980 can generally provide a user-friendly interface for users or entities to identify transactions that are of interest to them (i.e., associated with their public keys). It is further contemplated that in some embodiments, server 240 of FIG. 2 can include a wallet component 980 that stores the private keys of any entities in accordance with embodiments described herein. In this regard, the server 240 can include a node 110n that maintains a local copy of the blockchain, and the server 240 can automatically generate request approval or request denial transactions on behalf of the privileged entities based on rules defined therein. As such, the wallet component 980 of server 240 can store therein a private key for each of the nodes, and generate a transaction sent from a corresponding public key (also stored in the token generation smart contract) of the node to approve or deny requests stored on the blockchain.

The system log 130, as described herein, in particular embodiments, is an append-only file (e.g., a user cannot make changes to the file) that only includes a history access events and/or metadata associated with access events (e.g., the information in FIG. 4). In various embodiments, the system log records each input or other action performed on a user device while on a particular network (e.g., an enterprise network). As described herein, the system log 130 is copied on various nodes for validating or confirming a transaction for completion (e.g., to add blocks to a blockchain).

In some embodiments, the node 110n employs a transaction signing component (not shown) to digitally-sign the generated transaction with the stored private key associated with a client (e.g., user device 304) or node. In this way, the generated transaction is verifiably communicated from the client or node, via the communications component 920, to the distributed ledger network for storage onto the blockchain maintained thereby.

With reference to FIG. 10, computing device 008 includes bus 10 that directly or indirectly couples the following devices: memory 12, one or more processors 14, one or more presentation components 16, input/output (I/O) ports 18, input/output components 20, and illustrative power supply 22. Bus 10 represents what may be one or more busses (such as an address bus, data bus, or combination thereof). Although the various blocks of FIG. 10 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that this diagram is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 10 and reference to “computing device.”

In some embodiments, the computing device 008 represents the physical embodiments of one or more systems and/or components described above. For example, the computing device 008 can be the Nodes 110A-110F, the nodes 110N, the client 230n, the user device 304 and 306, and/or any of the components described with respect to FIGS. 3-6. The computing device 008 can also perform some or each of the blocks in the processes 700 and 800 in FIGS. 7 and 8. It is understood that the computing device 008 is not to be construed necessarily as a generic computer that performs generic functions. Rather, the computing device 008 in some embodiments is a particular machine or special-purpose computer. For example, in some embodiments, the computing device 008 is or includes: a multi-user mainframe computer system, a single-user system, a symmetric multiprocessor system (SMP), or a server computer or similar device that has little or no direct user interface, but receives requests from other computer systems (clients), a desktop computer, portable computer, laptop or notebook computer, tablet computer, pocket computer, telephone, smart phone, smart watch, or any other suitable type of electronic device.

Computing device 008 typically includes a variety of computer-readable media. Computer-readable media can be any available media that can be accessed by computing device 008 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 008. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 12 includes computer storage media in the form of volatile and/or nonvolatile memory. The memory may be removable, non-removable, or a combination thereof. Exemplary hardware devices include solid-state memory, hard drives, optical-disc drives, etc. Computing device 008 includes one or more processors 14 that read data from various entities such as memory 12 or I/O components 20. Presentation component(s) 16 present data indications to a user or other device. Exemplary presentation components include a display device, speaker, printing component, vibrating component, etc.

I/O ports 18 allow computing device 008 to be logically coupled to other devices including I/O components 20, some of which may be built in. Illustrative components include a microphone, joystick, game pad, satellite dish, scanner, printer, wireless device, etc. The I/O components 20 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 008. The computing device 008 may be equipped with depth cameras, such as, stereoscopic camera systems, infrared camera systems, RGB camera systems, and combinations of these for gesture detection and recognition. Additionally, the computing device 008 may be equipped with accelerometers or gyroscopes that enable detection of motion.

The present disclosure may include a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Definitions

“And/or” is the inclusive disjunction, also known as the logical disjunction and commonly known as the “inclusive or.” For example, the phrase “A, B, and/or C,” means that at least one of A or B or C is true; and “A, B, and/or C” is only false if each of A and B and C is false.

A “set of” items means there exists one or more items; there must exist at least one item, but there can also be two, three, or more items. A “subset of” items means there exists one or more items within a grouping of items that contain a common characteristic.

A “plurality of” items means there exists more than one item; there must exist at least two items, but there can also be three, four, or more items.

“Includes” and any variants (e.g., including, include, etc.) means, unless explicitly noted otherwise, “includes, but is not necessarily limited to.”

A “user” or a “subscriber” includes, but is not necessarily limited to: (i) a single individual human; (ii) an artificial intelligence entity with sufficient intelligence to act in the place of a single individual human or more than one human; (iii) a business entity for which actions are being taken by a single individual human or more than one human; and/or (iv) a combination of any one or more related “users” or “subscribers” acting as a single “user” or “subscriber.”

The terms “receive,” “provide,” “send,” “input,” “output,” and “report” should not be taken to indicate or imply, unless otherwise explicitly specified: (i) any particular degree of directness with respect to the relationship between an object and a subject; and/or (ii) a presence or absence of a set of intermediate components, intermediate actions, and/or things interposed between an object and a subject.

A “module” is any set of hardware, firmware, and/or software that operatively works to do a function, without regard to whether the module is: (i) in a single local proximity; (ii) distributed over a wide area; (iii) in a single proximity within a larger piece of software code; (iv) located within a single piece of software code; (v) located in a single storage device, memory, or medium; (vi) mechanically connected; (vii) electrically connected; and/or (viii) connected in data communication. A “sub-module” is a “module” within a “module.”

The terms first (e.g., first cache), second (e.g., second cache), etc. are not to be construed as denoting or implying order or time sequences unless expressly indicated otherwise. Rather, they are to be construed as distinguishing two or more elements. In some embodiments, the two or more elements, although distinguishable, have the same makeup. For example, a first memory and a second memory may indeed be two separate memories but they both may be RAM devices that have the same storage capacity (e.g., 4 GB).

The term “causing” or “cause” means that one or more systems (e.g., computing devices) and/or components (e.g., processors) may in in isolation or in combination with other systems and/or components bring about or help bring about a particular result or effect. For example, a server computing device may “cause” a message to be displayed to a user device (e.g., via transmitting a message to the user device) and/or the same user device may “cause” the same message to be displayed (e.g., via a processor that executes instructions and data in a display memory of the user device). Accordingly, one or both systems may in isolation or together “cause” the effect of displaying a message.

A “computing device” is any device with significant data processing and/or machine readable instruction reading capabilities including, but not necessarily limited to: desktop computers; mainframe computers; laptop computers; field-programmable gate array (FPGA) based devices; smart phones; personal digital assistants (PDAs); body-mounted or inserted computers; embedded device style computers; and/or application-specific integrated circuit (ASIC) based devices.

A “session” can be initiated when a user logs into a site, or is recognized by the site as returning user who is associated with activity on the site. For example, a site may recognize a returning user via cookies. A session can be considered terminated after a user logs off of a site or becomes inactive (or idle) on the site for a predetermined period of time. For example, after 30 minutes of idle time without user input (i.e., not receiving any queries or clicks), the system may automatically end a session.

“Automatically” means “without any human intervention.”

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

What is claimed is:

1. A computer-implemented method comprising:
storing, by a node of a distributed plurality of nodes, a received first transaction block onto a local copy of a blockchain maintained at least in part by the node, wherein the first transaction block includes information indicating a first access event of a system log, the first access event indicates an action performed by a user device, the system log includes a history of recorded user device actions;
receiving, by the node, a transaction request associated with adding a second transaction block onto the local copy of the blockchain, the transaction request includes a request to store a second access event to the system log; and
writing, by the node, the second transaction block on to the local copy of the blockchain and adding the second access event to the system log based at least on two or more of the plurality of nodes validating the transaction request.

2. The method of claim 1, wherein the plurality of distributed nodes correspond to a private system of computing devices within one organization, and wherein a copy of the system log is stored to each of the plurality of distributed nodes within the organization for the validating of the transaction request.

3. The method of claim 1, wherein the plurality of distributed nodes correspond to a consortium system of computing devices within two or more organizations, and where a copy of the system log is stored to each of the plurality of distributed nodes within the two or more organizations.

4. The method of claim 1, further comprising encrypting the first access event and the second access event, wherein the plurality of distributed nodes correspond to a public system of computing devices distributed throughout an internet network.

5. The method of claim 1, wherein the first access event includes an action of a group of actions consisting of: a download, a login attempt, a keystroke, performing a database operation, modifying a file, and accessing the file.

6. The method of claim 1, wherein the first transaction block includes one or more units of data of a group of units consisting of: a username of a user using privileged access, one or more commands executed using the privileged access, and any unsuccessful login attempts of the user.

7. The method of claim 1, further comprising anonymizing an origin of a payment associated with a transaction fee, the origin being included in the first transaction block.

8. The method of claim 1, further comprising:
receive a request associated with modifying the system log; and
deny the modifying of the system log based at least in part on the plurality of distributed nodes invalidating the request, each of the plurality of distributed nodes including a copy of the system log.

9. A non-transitory computer storage medium storing computer-useable instructions that, when used by one or more computing devices, cause the one or more computing devices to:
log one or more access events to a system log, the system log includes a history of recorded user device actions;
receive a request associated with modifying the system log; and
deny the modifying of the system log based at least in part on a plurality of distributed nodes invalidating the request, each of the plurality of distributed nodes including a copy of the system log, wherein the invalidating of the request includes comparing contents of the copy of the system log with the request.

10. The non-transitory computer storage medium of claim 9, wherein the invalidating includes determine that a transaction from a sending wallet address is invalid by not digitally authenticating a digital signature with the sending wallet address.

11. The non-transitory computer storage medium of claim 9, wherein the invalidating includes employing a consensus algorithm implemented within a consensus module including one or more algorithms of a group of algorithms consisting of: proof of work, proof of stake, proof of authority, practical Byzantine Fault Tolerance, and Federated Byzantine Agreements.

12. The non-transitory computer storage medium of claim 9, wherein the system log includes one or more blocks of a blockchain, and wherein each of the one or more blocks only contains information associated with one access event.

13. The non-transitory computer storage medium of claim 9, wherein one or more portions of the system log are distributed among one or more blocks of a blockchain, and wherein each of the one or more blocks include one or more access events and smart contract information.

14. The non-transitory computer storage medium of claim 9, wherein the system log includes a group of access events that include: a download, a login attempt, a keystroke, performing a database operation, modifying a file, and accessing the file.

15. A node of a distributed ledger system, comprising:
one or more processors; and
one or more computer storage media storing computer-useable instructions that, when used by the one or more processors, cause the one or more processors to:
write a first block onto a local copy of a blockchain maintained at least in part by the node, the first block includes information associated with a first access event, the first access event indicates a privileged action performed by a user device while initiating access to or connected to a computer network, the privileged action corresponds to a user or process having authority to make one or more administrative changes to the computer network or other resource within the computer network;
receiving, by the node, a transaction request associated with adding a second block onto the local copy of the blockchain; and
storing or not storing, by the node, the second block on to the local copy of the blockchain based on a plurality of nodes validating or invalidating the transaction request.

16. The node of claim 15, wherein the plurality of nodes correspond to a private system of computing devices within one enterprise, and wherein a copy of the first access event is stored to each of the plurality of nodes within the enterprise for the validating or invalidating of the transaction request.

17. The node of claim 15, wherein the plurality of nodes correspond to a consortium system of computing devices within two or more enterprises, and where a copy of the first access event is stored to each of the plurality of nodes within the two or more enterprises.

18. The node of claim 15, wherein the instructions further cause the one or more processors to further write a hash of the first access event to the first block, and wherein the first access event is not written in plaintext to any portion of the first block

19. The node of claim 15, wherein the first block includes data that includes: a username of a user using privileged access, one or more commands executed using the privileged access, a timestamp associated with the one or more commands, a source from where the one or more commands are sent, metadata associated with the user, a block ID of the first block, a block ID of a previous block in the blockchain, and information unrelated to the one or more commands.

20. The node of claim 15, wherein the instructions further cause the one or more processors to anonymize an origin of a payment associated with a transaction fee, the origin being included in the first block.
